(19) United States
(12) Patent Application Publication
(10) Pub. No.: US 2012/0320902 A1
(43) Pub. Date: Dec. 20, 2012

(54) Method for Time Synchronization in a Communication Network

(75) Inventors: Chongning Na, Beijing (CN); Dragan Obradovic, Ottobrunn (DE); Ruxandra Scheiterer, Geretsried (DE); Philipp Wolfrum, Muenchen (DE)

(73) Assignee: Siemens Aktiengesellschaft, Muenchen (DE)

(21) Appl. No.: 13/578,800

(22) PCT Filed: Dec. 29, 2010
(86) PCT No.: PCT/EP2010/070849

§ 371 Date: Aug. 13, 2012

(30) Foreign Application Priority Data
Feb. 11, 2010 (EP) 1001424.0
Jun. 2, 2010 (DE) 10 2010 022 525.8

(51) Int. Cl. H04W 56/00

(52) U.S. Cl. 370/350

(57) ABSTRACT

A method for time synchronization in a communication network having a plurality of nodes each comprising a first node and at least one second node, wherein the first node generates first cycle counting states according to a reference cycle frequency and the second node generates second cycle counting states according to an internal cycle frequency, wherein time synchronization is performed in consecutive synchronization cycles in which, starting from the first node, synchronization messages are consecutively transferred from one node to a further node and a synchronization message transmitted by the node includes a segment of information that is used for time synchronization in the node receiving the synchronization message, wherein time synchronization is performed in the second node based on an estimate of a first cycle counting state in combination with a linear-quadratic regulator to obtain a synchronized time comprising a controlled first cycle counting state.

### CROSS-REFERENCE TO RELATED APPLICATIONS

This is a U.S. national stage of application No. PCT/EP2010/070849 filed 29 Dec. 2010. Priority is claimed on European Application No. 10001424.0 filed 11 Feb. 2010 and German Application No. 10 2010 022 525.8 filed 2 Jun. 2010, the contents of which are incorporated herein by reference in their entirety.

### BACKGROUND OF THE INVENTION

1. Field of the Invention

The invention relates to communication networks and, more particularly, to a method for time synchronization in a communication network, a node in the communication network and a corresponding communication network.

2. Description of the Related Art

Communication networks are used in many technical fields to execute distributed processes automatically on a plurality of units. Particularly in industrial automation networks, it is very important for the automatic processes to be exactly synchronized with each other. To this end, the individual nodes in the communication network comprise corresponding clocks that are synchronized with a reference clock in a reference node. The reference node is frequently also referred to as a master node, while the other nodes with the internal clocks are, as rule, designated slave nodes.

Protocols for the synchronization of the clocks in a communication network known from the prior art are specified in the Institute of Electrical and Electronic Engineers (IEEE) industrial standard 1588, International Electrotechnical Commission (IEC) standard 61158 and IEEE standard 802.1AS. According to these protocols, synchronization messages are exchanged in the form of packets with time stamps. During this exchange, starting from the master node, a synchronization message is forwarded consecutively between the slave nodes. The synchronization message sent from the master node contains a time stamp of the first cycle counting state according to the reference clock at the time of transmission of the message. The slave nodes process this information and re-transmit synchronization messages. During this re-transmittal, each slave node adds the estimated delays between the time of transmission of the synchronization message in the preceding node and its own time of transmission to the first cycle counting state in the received synchronization message. The cycle counting state resulting therefrom is inserted in the synchronization message to be transmitted. Based on the information in the received synchronization messages, each slave node is able to synchronize its second cycle counting states according to its internal clock with the first cycle counting states according to the reference clock.

One problem with the above-described synchronization of the clocks is the fact that, due to measuring errors during the time determination, varying frequencies of the individual clocks, random environmental effects and unknown variations relating to the time delay between the reception and transmission of synchronization messages, the internal clocks in the slave nodes cannot be synchronized with the reference clock of the master node with sufficient precision.

In order to take into account the above uncertainties with synchronization of the clocks, it is known from the publication C. Na, R. L. Scheiterer, D. Obradovic, A Kaiman Filter Approach To Clock Synchronization Of Cascaded Network Elements, 1st IFAC Workshop on Estimation and Control of Networked Systems (NecSys'09), 24-26 Sep., 2009, Venice, Italy (“Scheiterer”) and a European patent application based on this publication (i.e., EPA 09 012 028.8) to use a probabilistic model for state variables of the nodes as a basis for estimating the first cycle counting states in each slave node and to use the estimated first cycle counting states to synchronize internal clocks with the reference clock. In this case, the course of the second cycle counting states of the respective second node in dependence upon first cycle counting states is not constant and upon reception of a new synchronization message, which causes the synchronization to be updated, step changes can occur.

### SUMMARY OF THE INVENTION

It is an object of the invention to provide high-precision time synchronization, which is uniform over time, in a communication network.

This and other objects and advantages are achieved by providing a method for time synchronization in a communication network having a plurality of nodes, where the nodes comprise a first node and at least one second node. Here, the first node generates first cycle counting states according to a reference cycle frequency, which is based on a reference clock in this first node or which the first node receives from an absolute time source, e.g., GPS or DCF77. The at least one second node generates second cycle counting states according to an internal cycle frequency, which is set by an internal clock in the respective second node. In accordance with the method of the invention, the time synchronization is performed in consecutive synchronization cycles, in which, starting from the first node, synchronization messages are each consecutively transferred from a node to a further node. In addition, a synchronization message from a node contains a piece of information, which is used for time synchronization in the node receiving the synchronization message.

In accordance with the method of the invention, time synchronization occurs in a respective second node of at least a part of the second nodes and in particular in all second nodes based on steps i) and ii) explained below. In step i), a first cycle counting state for a second cycle counting state measured in a respective second node is estimated based on an estimation method with the aid of the information in a received synchronization message. Conventional estimation methods can be used for this (e.g., a decentralized or a centralized Kalman filter). Next, in a step ii), a controlled first cycle counting state based on a controlled system is then determined from the estimated first cycle counting state with the aid of a linear-quadratic regulator or a linear-quadratic Gaussian (LQG) regulator, which contains as a control variable a compensation factor, which estimates a current duty cycle ratio of the reference cycle frequency to the internal cycle frequency of the respective second node. Here, the controlled first cycle counting state represents the synchronized time. The LQG regulator is in particular suitable if no Kalman filter is used in step i).

The method in accordance with the invention is based on the knowledge that regulation based on a linear quadratic regulator, which is known per se from the prior art, can ensure precise synchronized time which remains uniform over time and hence achieves good synchronization of an internal cycle frequency of the respective second node with the reference cycle frequency of the first nodes. Here, the use of a compensation factor takes into account frequency fluctuations in the internal cycle frequency of the respective second node in a suitable manner.

In a particularly preferred embodiment of the method in accordance with the invention, the control variable is updated after each reception of a synchronization message in the respective second node and supplied to the plant. This ensures continuous updating of the synchronization. Here, the control variable is preferably supplied via a zero-order hold (ZOH) element of the plant, in order, in this way, to map the discrete updates on continuous dynamics of the plant.

In a preferred embodiment of the method in accordance with the invention, the controlled system for the linear-quadratic regulator at the time of the reception of a synchronization message in the k-th synchronization cycle in the n-th second node and immediately before an updating of the control variable is written as follows:

\hat{x}ₙ^{C}(k)=\hat{x}ₙ^{C}(k−1)+oₙ(k−1)·aₙ(k),

where \hat{x}ₙ^{C}(k) is the controlled first cycle counting state at the time of reception of the synchronization message in the k-th synchronization cycle,
where oₙ(k−1) is the compensation factor used in the (k−1)-th synchronization cycle, and
where aₙ(k) is the time difference between two synchronization messages received consecutively in the respective second node, expressed in second cycle counting states according to the internal cycle frequency of the n-th second node.

The dynamics of the controlled system for the linear-quadratic regulator after updating of the control variable at the time of reception of the synchronization message in the k-th synchronization cycle in the n-th second node until the next updating of the control variable reads as follows:

xₙ^{C}=\hat{x}ₙ^{C}(k)+oₙ(k)·(Sₙ−TS(Sₙⁱⁿ(k))),

where xₙ^{C} is the controlled first cycle counting state at the time of a measured second cycle counting state Sₙ of the respective second node (SLn) between the two updates, and
where TS(Sₙⁱⁿ(k)) is the measured second cycle counting state of the respective second node at the time of reception of the k-th synchronization.

The above compensation factor oₙ(k) for the k-th synchronization cycle is preferably expressed as:

$${o}_{n} ( k ) = {\hat{R}}_{n} ( k ) + \frac{( {\hat{x}}_{n}^{in} - {\hat{x}}_{n}^{C} ( k ) )}{β + {a}_{n} ( k )} ,$$

where \hat{R}ₙ(k) is an estimated value for the duty cycle ratio of the reference cycle frequency to the internal cycle frequency of the n-th second node,
where \hat{x}ₙⁱⁿ is the first cycle counting state estimated in step i), and
where β is a positive factor, preferably lying between 5 and 20.

The derivation of this compensation factor may be found herein in the more detailed description. Corresponding methods for estimating the duty cycle ratio are sufficiently well known from the prior art and an embodiment of a method is also explained in the more detailed description.

In a particularly preferred embodiment, the first cycle counting state is estimated in step i) using an estimation method comprising a stochastic state estimator and, in particular, a Kalman filter. The Kalman filter is generally known from the prior art and estimates an unknown state of a system based on a corresponding state space model, which describes, on the one hand, the change in the state to be estimated (i.e., a state transition model) and, on the other, the relationship between the state and corresponding known observables (i.e., an observation model). The present inventors were able to demonstrate that a combination of a state estimation by the Kalman filter and a linear-quadratic regulator represents an optimal linear-quadratic Gaussian (LQG) regulator, where the LQG regulation is sufficiently well known from the prior art. Hence, a combination of a Kalman filter and a linear-quadratic regulator guarantees particularly good time synchronization.

In another particularly preferred embodiment, the first cycle counting state is estimated using an estimation method comprising a Kalman filter, which estimates the first cycle counting state at the time of reception of a synchronization message in the respective second node and an associated stochastic variance as a state, and uses the information in the received synchronization message as an observable. Here, the information in a synchronization message preferably comprises an estimated first cycle counting state at the time of transmission of the synchronization message in the respective second node and an associated stochastic variance.

In a particularly preferred embodiment of the method in accordance with the invention, the following state space model for the Kalman filter is used in the n-th second node for the k-th synchronization cycle:

xₙⁱⁿ(k)=xₙⁱⁿ(k−1)+aₙ(k)·\hat{R}ₙ(k)+aₙ(k)·ηₙ^{a}(k),

xₙ₋₁^{out}(k)=xₙⁱⁿ(k)−cₙ(k)·\hat{R}ₙ(k)−cₙ(k)+υₙ(k),

where xₙⁱⁿ(k) is the first cycle counting state at the time of reception of the synchronization message in the n-th second node in the k-th synchronization cycle,
where xₙ₋₁^{out}(k) is the first cycle counting state on the transmission of the synchronization message in the (n−1)-th second node or in the first node in the k-th synchronization cycle,
where aₙ(k) is the time difference between two synchronization messages received consecutively, expressed in second cycle counting states according to the internal cycle frequency of the n-th second node,
where \hat{R}ₙ(k) is an estimated value for the duty cycle ratio of the reference cycle frequency to the internal cycle frequency of the n-th second node,
where cₙ(k) is an estimated time delay between the time of transmission of the synchronization message from the (n−1)-th second node and the time of reception of this synchronization message in the n-th second node, expressed in second cycle counting states according to the internal cycle frequency of the n-th second node and
where ηₙ^{a}(k), ηₙ^{c}(k) and υₙ(k) are Gaussian noise terms.

A derivation of the above-described state space model, which is based on the state space model described in the publications EPA 09 012 028.8 or Scheiterer can be found in the detailed description. Corresponding methods for estimating the duty cycle ratio or the time delay between the reception and transmission of synchronization message are sufficiently well known from the prior art.

In a further particularly preferred embodiment of the method in accordance with the invention, the estimated first cycle counting state at the time of transmission of the subsequent synchronization message in the respective second node and the associated stochastic variance are calculated from the first cycle counting state estimated by the Kalman filter at the time of reception of a synchronization message in the respective second node and the associated stochastic variance with the aid of a node processing time and inserted in the subsequent synchronization message. Here, the node processing time represents an estimated time delay in the respective second node between the reception of the synchronization message received in the respective second node and the transmission of the subsequent synchronization message. This estimated time delay can be determined by a second node in a simple manner via its local second cycle counting states.

The time synchronization used in accordance with the disclosed embodiments of the method of the invention is preferably based on one of the aforementioned IEEE 1588, IEC 61588 or IEEE 802.1AS standards. In a further embodiment, the nodes communicate in the communication network based on the known PROFINET standard. Moreover, the method in accordance with the disclosed embodiments of the invention is preferably used in a communication network in an industrial automation system.

It is also an object of the invention to provide a node for use as a second node in a method for time synchronization in a communication network, where the node is configured to perform the time synchronization according to steps i) and ii) of the method in accordance with the disclosed embodiments of the invention.

It is also an object of the invention to provide a communication network having a plurality of nodes, where the communication network comprises a first node and at least one second node in accordance with the invention. Here, the communication network is preferably configured to perform one or more of the above-described preferred embodiments of the method in accordance with the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

Exemplary embodiments of the invention are described below in detail with reference to the attached figures, in which:

FIG. 1 is a schematic block diagram illustrating a plurality of nodes in a communication network, which exchange synchronization messages in accordance with an embodiment of the invention;

FIG. 2 is a diagram illustrating the transmission of synchronization messages in accordance with an embodiment of the invention;

FIG. 3 is a schematic block diagram illustrating the structure of a second node in a communication network configured to perform an embodiment of the method in accordance with the invention; and

FIG. 4 is a flowchart of the method in accordance with the invention.

### DETAILED DESCRIPTION OF THE PREFERRED EMBODIMENTS

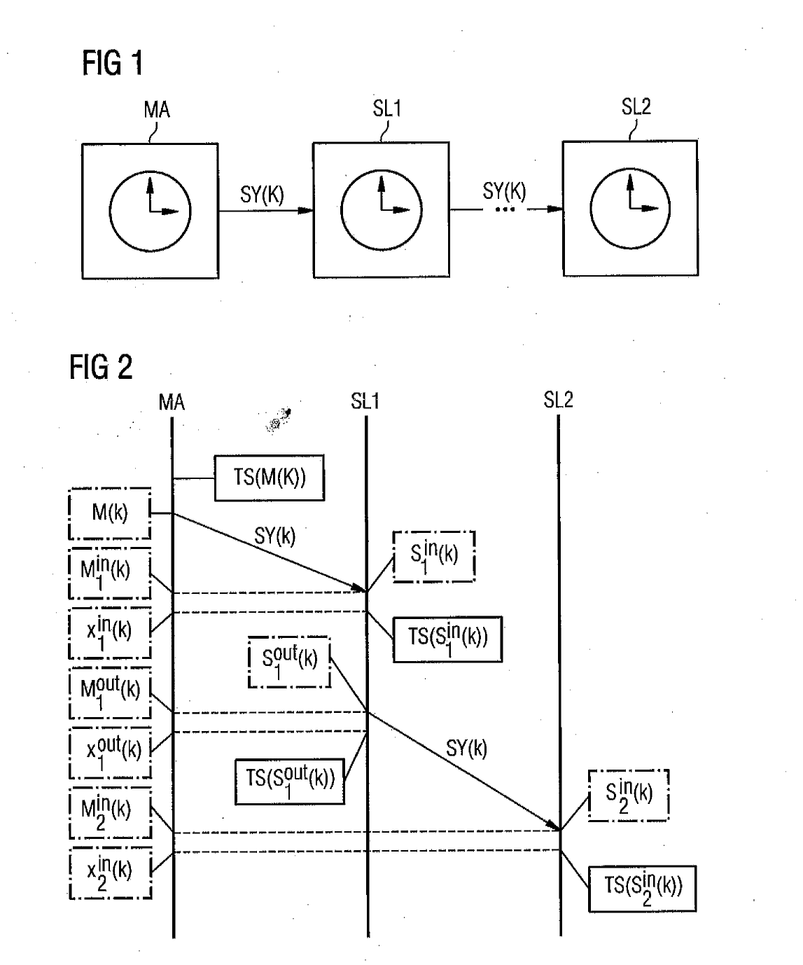

FIG. 1 shows a chain of nodes in a communication network in which an embodiment of the method in accordance with the invention is implemented. The communication network comprises a first node including a master node MA and a plurality of second nodes comprising slave nodes, where FIG. 1 shows two slave nodes SL1 and SL2. The master node MA contains a reference clock, which generates a reference cycle frequency. On the other hand, the illustrated individual slave nodes SL1, SL2, contain separate internal clocks, which generate corresponding internal cycle frequencies. In the communication network according to FIG. 1, a suitable time synchronization protocol, for example the precision time protocol (PTP) protocol according to IEEE standard 1588, is used to synchronize the internal clock of each slave node with the reference clock of the master node MA. To this end, synchronization messages SY(k) are forwarded from one node to the next node. That is, a synchronization message is sent from the master node MA to the slave node SL1 and from the slave node SL1 to the slave node SL2 etc. until the last slave node SLN (not shown) in the chain of slave nodes has been reached.

The transmission of synchronization messages is repeated in consecutive synchronization cycles, where k designates the current number of the synchronization cycle. To perform synchronization of the clocks, the synchronization messages SY(k) each contain a time stamp representing the cycle counting state of the reference clock at the time of transmission of the synchronization message. In the following, cycle counting states of the reference clock are also referred to as first cycle counting states. The corresponding cycle counting states based on the internal clock of the respective slave nodes are also referred to in the following as second cycle counting states. During the forwarding of a synchronization message from one slave node to the next, the first cycle counting state in the synchronization message is updated in that the time interval between the transmission of the synchronization message at the previous node until the transmission of the synchronization message in the current node is added to the time of the reference clock of the previously received synchronization message. This time interval is made up of the line delay and the bridge delay. Here, the line delay is the time interval between the transmission of the synchronization message in the preceding node and the reception of this synchronization message in the current node. On the other hand, the bridge delay is the time interval between the reception of a synchronization message in the current node and the transmission of the same synchronization message to the next mode. The line delay and bridge delay are subject to measuring errors.

In FIG. 2, the three vertical lines represent the measured time in the master node MA or the slave node SL1 or the slave node SL2. The time axis according to these vertical lines extends from top to bottom, i.e., future events are represented at lower positions along the vertical lines. The reference clock of the master node MA works with the reference cycle frequency and the clocks of the slave nodes SL1 and SL2 work with corresponding internal cycle frequencies, which can differ from one another and can also differ from the reference cycle frequency. The time in each node is measured based on the corresponding clock of the respective node, i.e., with the corresponding cycle frequency of the clock of the node in question.

In the diagram in FIG. 2, the function TS refers to the time stamp of a cycle counting state and represents the measured value of a cycle counting state. Fluctuations (i.e., jitter) and frequency drift can cause the time stamp to differ from the true cycle counting state. FIG. 2 shows the transmission of the synchronization message SY(k), which is transmitted from the master node MA to the true or actual first cycle counting state value M(k). This cycle counting state value includes the measured first cycle counting state value TS(M(k)), which differs therefrom. The message SY(k) is received by the slave node SL1 for the second cycle counting state S₁ⁱⁿ(k), where this second cycle counting state corresponds to the measured second cycle counting state TS(S₁ⁱⁿ(k). The time delay between the transmission of the synchronization message from the master node MA and the reception of this message in the slave node SL1 is designated as a line delay and estimated using a suitable estimation method. This estimation method also includes the transmission of suitable messages for determination of the line delay. The aforementioned IEEE standard 1588 describes an estimation method of this kind, which can also be used in the method in accordance with the invention described here. After the reception of a synchronization message, following the expiration of a bridge delay representing the internal processing time in a node, a new synchronization message is sent from the slave node SL1 to the slave node SL2. This new message is sent at the time of the true second cycle state S₁^{out}(k) of the slave node SL1. Here, this true second cycle counting state corresponds to the second cycle counting state TS(S₁^{out}(k) measured in the slave node SL1.

The synchronization message sent from the slave node SL1 is received in the slave node SL2 at the true second cycle counting state S₂ⁱⁿ(k) of the slave node SL2. This cycle counting state corresponds in turn to the measured second cycle counting state TS(S₂ⁱⁿ(k)) of the slave node SL2. The above-described method is then repeated, i.e., a new synchronization message SY(k) is sent to the next slave node etc. until all N slave nodes in the communication network have received a synchronization message. As shown in FIG. 2, the measured second cycle counting states (i.e., the time stamp TS of the corresponding second cycle counting states of the respective slave nodes) are linked to corresponding first cycle counting states of the reference clock, where these first cycle counting states are designated by variables commencing with the letter “x” along the first vertical line. Similarly, the true second cycle counting states are linked to corresponding true first cycle counting states, which are designated in FIG. 2 by corresponding variables along the first vertical line commencing with the letter “M”.

The synchronization described with reference to FIG. 1 and FIG. 2 entails the problem that, during synchronization of the individual clocks with each other, uncertainties occur as a result of measuring errors, fluctuations, quantization errors, random frequency drift and the like. As a result of these errors, the synchronization of the internal clocks of the slave nodes with the reference clock of the master node is frequently not sufficiently precise, which is problematic in applications requiring exact synchronization of the clocks during the performance of combined processes via the nodes of the communication network. In particular, in the field of industrial automation processes, exact synchronization of the clocks between the nodes is very important.

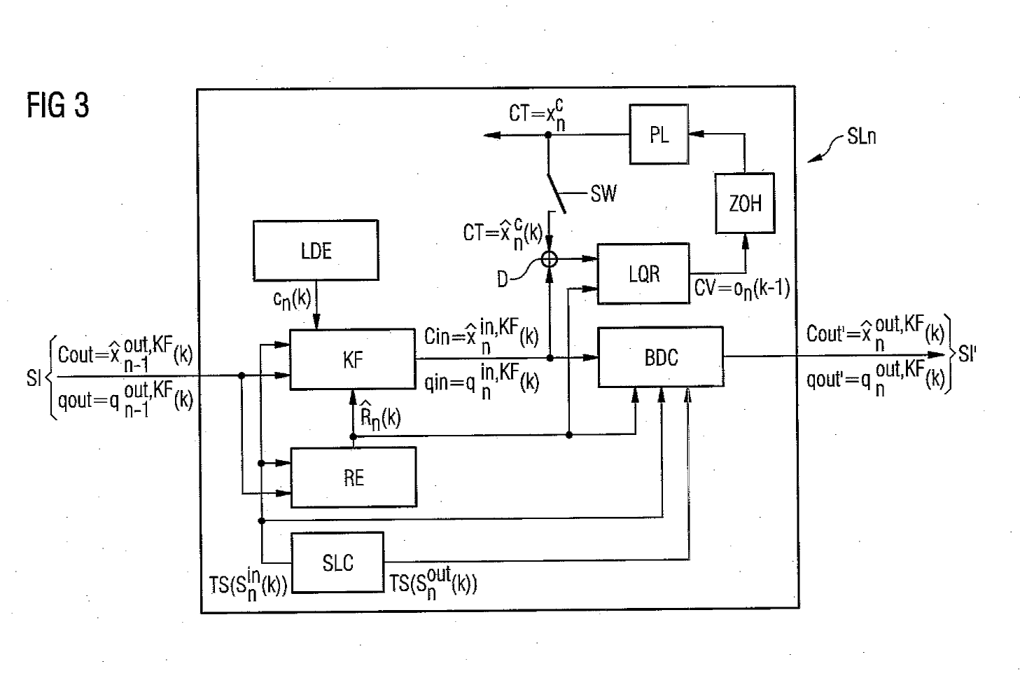

To achieve exact synchronization of this kind, in the embodiment of the method in accordance with the invention as described below, in the respective second node, a stochastic state estimator comprising a Kalman filter is combined with a control loop based on a linear-quadratic regulator, as described below in more detail with reference to FIG. 3. However, firstly, a few definitions of terms used in the following description of FIG. 3 are given. The definitions are as follows:

TS(x) is the time stamp of the local time of a node with the corresponding cycle counting state.
Rₙ(k) is the k-th RFC ratio, i.e., the frequency response ratio of the reference cycle frequency of the reference clock to the cycle frequency of the internal clock of the slave node SLn in the k-th synchronization cycle.
M(k) is the actual first cycle counting state when the k-th synchronization message (i.e., the synchronization message in the k-th synchronization cycle) is transmitted from the master node, where the measured cycle counting state TS(M(k)) belongs to this first cycle counting state.
Sₙⁱⁿ(k) is the actual second cycle counting state of the slave node SLn when the k-th synchronization message arrives in the slave node SLn, where the measured second cycle counting state TS(Sₙⁱⁿ(k)) belongs to this second cycle counting state.
xₙⁱⁿ(k) is the first cycle counting state of the master node at the time when the second cycle counting state of the slave node SLn actually has the value TS(Sₙⁱⁿ(k)).
Sₙ^{out}(k) is the actual second cycle counting state value of the slave node SLn when the k-th synchronization message is transmitted from the slave node SLn, where the measured second cycle counting state TS(Sₙ^{out}(k)) belongs to this second cycle counting state.
xₙ^{out}(k) is the first cycle counting state of the master node at the time when the second cycle counting state of the slave node SLn is actually TS(Sₙ^{out}(k)).
aₙ(k))=TS(Sₙⁱⁿ(k))=TS(Sₙⁱⁿ(k−1)) is the local time difference between the arrival of two consecutive synchronization messages in the slave node SLn, which is measured in second cycle counting states of the internal clock of the slave node SLn.
bₙ(k)=TS(Sₙ^{out}(k))−TS(Sₙⁱⁿ(k)) is the bridge delay in the local time according to the second cycle counting states of the slave node SLn.
cₙ(k) is the line delay estimated in the local time according to the second cycle counting states of the slave node SLn.
υₙ(k) is a Gaussian random variable containing the combined effects of all uncertainties in the time measurements. Here, the Gaussian random variable υₙ(k) corresponds to the random variable defined in the publications EPA 09 012 028.8 and Scheiterer. Further references to derivations already performed in the aforementioned publications EPA 09 012 028.8 and Scheiterer are made below. Therefore, the disclosure content of these publications is hereby incorporated in the present application by reference thereto in their entirety. FIG. 3 is a schematic block diagram illustrating the structure of the n-th slave node SLn, which lies at the n-th position in the chain of synchronization messages transferred starting from the master node. In the exemplary configuration depicted in FIG. 3, the slave node SLn receives a synchronization message containing corresponding synchronization information SI and, following the processing described below, sends a new synchronization message with corresponding synchronization information SI′. Here, the components shown in FIG. 1 facilitate the generation of a synchronized controlled time, which is designated CT. On the other hand, the internal free-running clock of the slave node SLn in FIG. 1 is designated SLC. In the following, variables marked with a circumflex (̂) are estimated variables of the respective variables.

To estimate the first cycle counting state on the reception of the synchronization message, in the slave node SLn, the synchronization information SI of the received synchronization message is initially supplied to a local Kalman filter KF. Here, the synchronization information comprises a first cycle counting state Cout=\hat{x}ₙ₋₁^{out,KF}(k) estimated in the preceding slave node with the corresponding variance qout=qₙ₋₁^{out,KF}(k). This estimated first cycle counting state is determined in the preceding slave node in the same manner as the estimated first cycle counting state is determined in the slave node SLn for the synchronization information SI′. The Kalman filter KF, the general structure of which is known from the prior art, uses a state space model, which is explained in more detail below, to estimate the first cycle counting state Cin=\hat{x}ₙ^{in,KF}(k) with the corresponding variance qin=qₙ^{in,KF}(k) at the time of reception of the synchronization message with the synchronization information SI in the slave node SLn. For performing the estimation with the Kalman filter, further variables used are the estimated line delay cₙ(k), which is estimated in a line delay estimator LDE using a method which is known per se. The Kalman filter KF with the internal clock SLC also uses measured time stamps of second cycle counting states TS(Sₙⁱⁿ(k)) in order on this basis to determine the above variable aₙ(k)=TS(Sₙⁱⁿ(k))−TS (Sₙⁱⁿ(k−1)). In addition, the Kalman filter is supplied with the duty cycle ratio \hat{R}ₙ(k) estimated in the slave node SLn, which designates the ratio between the reference cycle frequency of the master node to the cycle frequency of the internal clock of the slave node SLn. This duty cycle ratio is determined in an estimator RE, where second cycle counting states TS(Sₙⁱⁿ(k)) and the variable Cout are again supplied for this determination. The performance of the estimation of the duty cycle ratio is based on a method known per se from the prior art and is described in more detail below.

The estimated value Cin, one of the output variables of the Kalman filter KF, is then supplied to an optimal linear quadratic regulator LQR which, in the following, is also referred to as an LQR regulator. LQR regulation is generally known from the prior art and the special embodiment of the regulator used in FIG. 3 is described in more detail in mathematical terms below. The regulator LQR receives the estimated first cycle counting state Cin via the differentiating element D. The regulator also uses the duty cycle ratio \hat{R}ₙ(k). Here, The control variable CV=oₙ(k−1) of the regulator represents an estimation of the duty cycle ratio and is also referred to below as a compensation factor or offset compensation factor (OCF). This discrete control variable, which is updated at the time of reception of a new synchronization message, is supplied with a zero order hold (ZOH) element. This ZOH element is sufficiently well known from the prior art and generates a continuous step function from the discrete values of the OCF factor. Finally, the output from the ZOH element is supplied to the controlled system (PL) from which a controlled time CT=\hat{x}ₙ^{c}(k) comprising a controlled first cycle counting state is determined, where the dynamics of the controlled system also express the controlled time for intermediate values between the times of two received synchronization messages (see equation (19)). The controlled first cycle counting state CT, which is obtained by the dynamics of the controlled system PL, is the synchronized cycle counting state of the slave node. In FIG. 3, it is also indicated by a switch SW that the controlled first cycle counting state CT is also supplied to the differential element D on each new calculation of Cin, triggered by a newly received synchronization message, where the element D calculates the difference between Cin and CT, which is then supplied to the LQR regulator.

The combination of a Kalman filter KF with an LQR regulator LQR used as depicted in FIG. 3 supplies an optimal regulator in the sense that the sum total of the accumulated quadratic error between the actual master cycle counting state and the controlled first cycle counting state and the weighted accumulated quadratic deviation of the control variable from the reference control variable is minimized. The present inventors were able to demonstrate that the combination of filtering of the noisy first cycle counting state in the synchronization information SI with the Kalman filter and the use of the output from the Kalman filter as a reference for the LQR regulator is equivalent to a linear-quadratic Gaussian (LQG) regulator, which follows the time according to the true first cycle counting states of the master node in the presence in its entirety of Gaussian process and measurement noise in an optimal manner. A LQG regulator and the linear quadratic Gaussian control on which this regulator is known are sufficiently well known from the prior art and will not be explained in any further detail.

To enable the slave node in FIG. 3 to again generate suitable synchronization information for a synchronization message to be transmitted, the outputs Cin and qin of the Kalman filter KF are supplied to the component BDC, which the bridge delay compensates and hence generates an estimated first cycle counting state Cout′=\hat{x}ₙ^{out,KF}(k) from the estimated first cycle counting state an Cin=\hat{x}ₙ^{in,KF}(k) at the time of the input of the synchronization message and the associated variance qin at the time of the transmission of the next synchronization message with the associated gout′=qₙ^{out,KF}(k). These generated values are integrated in the synchronization message transmitted by the slave node SLn as new synchronization information SI′. The calculation performed by the component BDC calculation is explained in more detail below. Here, in addition to the output from the Kalman filter KF, the estimated duty cycle ratio k(k) of the estimator RE and second cycle counting states measured in the local time of the slave node (indicated by TS(Sₙⁱⁿ(k)) and TS(Sₙ^{out}(k)) are used.

The individual calculations performed by the components shown in FIG. 3 are explained in detail below. The Kalman filter KF is based on a state space model, which was previously used in references [1] and [2] as a probabilistic description of uncertainties present in the system. This state space model comprises the following equations:

xₙⁱⁿ(k)=xₙⁱⁿ(k−1)+aₙ(k)·Rₙ(k) Eq. (1)

xₙ^{out}(k)=xₙⁱⁿ(k)+bₙ(k)·Rₙ(k) Eq. (2)

TS(M(k))=x₁ⁱⁿ(k)−c₁(k)·R₁(k)+vᵢ(k) Eq. (3)

xₙ₋₁^{out}(k)=xₙⁱⁿ(k)−cₙ(k)·Rₙ(k)+υₙ(k) (for n>1) Eq. (4)

The equations (1) to (4) are defined in Scheiterer.

The variables in the above equations fall into the following categories:
TS(M (k)), aₙ(k), (n=1, . . . N), cₙ(k), (n=1, . . . N) and bₙ₋₁(k), (n=2, . . . N) are known variables, which were defined previously. Here, aₙ(k), bₙ(k) and cₙ(k) represent local time estimates of the interval between two consecutive synchronization messages, the bridge delay or the line delay.
   xₙⁱⁿ(k), xₙ^{out}(k) are hidden state variables and have to be estimated.
   Rₙ(k) is a parameter estimated in a separate process, as is explained below with reference to equations (5) and (6). It is also possible that Rₙ(k) together with xₙⁱⁿ(k) and xₙ^{out}(k) is estimated as a hidden state variable, as is also described in patent application EPA 09 012 928.8.
υₙ(k) is a Gaussian random variable with υₙ(k)˜N(0,σ_{κ}²) and a suitably selected variance σ_{υ}², where the variance is defined according to the hardware and software used in the node. The definition of this variance is within the scope of the person skilled in the art. υₙ(k) models the uncertainties of errors with time measurement (i.e., stamping errors) and with the determination of the line delay. A derivation for the expression υₙ(k) can be found in the publications EPA 09 012 028.8 and Scheiterer.

As shown in FIG. 3, an estimated duty cycle ratio \hat{R}ₙ(k) is used with Kalman filtering. Here, the estimation of this duty cycle ratio in the component RE is performed using the following expression:

$${\hat{r}}_{n}^{pre} ( k ) = \frac{{\hat{x}}_{n - 1}^{out , KF} ( k ) - {\hat{x}}_{n - 1}^{out , KF} ( k - 1 )}{TS ( {S}_{n}^{in} ( k ) ) - TS ( {S}_{n}^{in} ( k - 1 ) )} n > 1 \qquad Eq . ( 5 )$$

Here, \hat{x}ₙ₋₁^{out,KF}(k) corresponds to the estimated first cycle counting state in the received synchronization information SI, which was determined via a Kalman filter of the preceding slave node. The calculation of \hat{x}ₙ₋₁^{out,KF}(k) is explained below. The following applies for the first slave node SL1, which receives a synchronization message: \hat{x}ₙ₋₁^{out,KF}(k)=TS(M(k)). Consecutive estimations obtained according to equation (5) are averaged as follows for the final calculation of the estimated duty cycle ratio \hat{R}ₙ(k):

$${\hat{R}}_{n} ( k ) = \frac{1}{L} {\sum }_{l = 0}^{L - 1} {\hat{r}}_{n}^{pre} ( k - l ) \qquad Eq . ( 6 )$$

This generates a better estimation. The uncertainty of the estimation is in turn modeled by a Gaussian random variable η˜N(0,σ_{η}²), where the choice of the variance σ_{η}² once again lies within the scope of the person skilled in the art. This produces the following relationship between the true duty cycle ratio Rₙ(k) and the estimated duty cycle ratio \hat{R}ₙ(k):

Rₙ(k)=\hat{R}ₙ(k)+ηhd n(k) Eq. (7)

Using the above equation (7), the following state space model is then used for the Kalman filter KF in FIG. 3:

### State Transition Model:

xₙⁱⁿ(k)=xₙⁱⁿ(k−1)+aₙ(k)·\hat{R}ₙ(k)+aₙ(k)·ηₙ^{a}(k) Eq. (8)

### Observation Model:

xₙ₋₁^{out}(k)=xₙⁱⁿ(k)−cₙ(k)·\hat{R}ₙ(k)−cₙ(k)·ηₙ^{c}(k)+υₙ(k) Eq. (9)

Here, x₀^{out}(k)=TS(M(k)) so that the above equation (9) can be used to represent the expression according to the equations (3) and (4) as an equation. The superscript designations a and c indicate that the two noise terms ηₙ^{a}(k) and ηₙ^{c}(k) are random variables which may be independent of each other and identically distributed and derived from the same distribution η˜N(0,σ_{η}²) of the equation (7). The observable used in the observation model of a Kalman filter is conventionally an actually observed variable, which is in fact observed in the system with associated noise. In the synchronization described here, the variable xₙ₋₁^{out}(k) should be used as an observable, i.e., the master time at the time at which the preceding slave node sends the synchronization message SY(k), although this is not an observed variable in the conventional sense. Therefore, instead of this, the best available estimation therefor is used, i.e., a first cycle counting state estimated by the preceding slave node. Nevertheless, in the Kalman filter used here, this variable is treated as an observable because it is the only “observation” available at the time of reception of the synchronization message. The estimated value of the observables is designated below as \hat{x}ₙ₋₁^{out}(k).

The following explains the Kalman filtering performed on the basis of the above equations (8) and (9), where the steps performed are per se very familiar to the person skilled in the art and are only explained for elucidation.

According to the Kalman filter, initially a state is predicted as follows:

\hat{x}ₙ^{in,KF}(k,k−1)=\hat{x}ₙ^{in,KF}(k−1,k−1)+aₙ(k)·\hat{R}ₙ(k) Eq. (10)

Here, the predicted estimated variance is written as follows

qₙ^{in,KF}(k,k−1)=qₙ^{in,KF}(k−1,k−1)+aₙ²(k)·σ_{η}² Eq. (11)

Then, the innovation or the measuring residual (difference between the actual observation and the prediction according to the observation model) is determined as follows:

zₙ(k)=\hat{x}ₙ₋₁^{out}(k)−(\hat{x}ₙ^{in,KF}(k,k−1)−cₙ(k)·\hat{R}ₙ(k)) Eq. (12)

Here, the residual variance is expressed as follows:

sₙ(k)=qₙ₋₁^{out,KF}(k,k)+qₙ^{in,KF}(k,k−1)+cₙ²(k)·σ_{η}²+σ_{υ}² Eq. (13)

On the basis of the optimal Kalman gain

$${g}_{n}^{KF} ( k ) = \frac{{q}_{n}^{in , KF} ( k , k - 1 )}{{s}_{n} ( k )} , \qquad Eq . ( 14 )$$

the following updated value is obtained for the state estimation:

\hat{x}ₙ^{in,KF}(k,k)=\hat{x}ₙ^{in,KF}(k,k−1)+gₙ^{FK}(k)·zₙ(k) Eq. (15)

The variance for this updated state estimation is expressed as follows:

qₙ^{in,KF}(k,k)=(1−gₙ^{KF}(k))·qₙ^{in,KF}(k,k−1). Eq. (16)

The values obtained according to equations (15) and (16) correspond to the output Cin or qin from the Kalman filter KF in FIG. 3.

As shown in FIG. 3, the outputs Cin and qin are inter alia supplied to the component BDC, which determines corresponding outputs at the time of transmission of the synchronization message by the slave node taking into account the bridge delay. Here, the bridge delay bₙ(k) is determined in the component BDC using corresponding measured second cycle counting states as follows:

bₙ(k)=TS(Sₙ^{out}(k))−TS(Sₙⁱⁿ(k))

With the aid of this bridge delay and using the estimated duty cycle ratio of the estimator RE, the component SDC then calculates the first cycle counting state on the transmission of the synchronization message as follows:

\hat{x}_{out,KF}(k,k)=\hat{x}ₙ^{in,KF}(k,k)+bₙ(k)·\hat{R}ₙ(k) Eq. (17)

Here, the estimated variance is expressed as follows:

qₙ^{out,KF}(k,k)=qₙ^{in,KF}(k,k)+bₙ²(k)·σ_{Θ}² Eq. (18)

The values according to equations (17) and (18) are then integrated in the synchronization information SI′ of the transmitted synchronization message as corresponding values Cout′ and qout′. In the case of n=1, the master node sends the following values to the first slave node:

\hat{x}₀^{out,KF}(k,k)=TS(M(k)) and q₀^{out,KF}(k,k)=0.

The following now describes the regulation performed by the LQR regulator in detail. The regulation ensures that, in addition to the second cycle counting states Sₙ according to the internal clock of the slave node SLn, the controlled cycle counting state CT=\hat{x}ₙ^{c}(k) is generated. From this, it is possible to calculate the synchronized time with the aid of the continuous dynamics of the controlled system PL in FIG. 3 for each local time Sₙ of the slave node SLn as follows:

xₙ^{C}=\hat{x}ₙ^{C}(k)+oₙ(k)·(Sₙ−TS(Sₙⁱⁿ(k))) Eq. (19)

for TS(Sₙⁱⁿ(k))≦Sₙ<TS(Sₙⁱⁿ(k+1)).

Here, oₙ(k) designates the OCF factor at the time k (i.e., on reception of the k-th synchronization message). The OCF factor is generated by the LQR regulator LQR of the slave node SLn and is based on the reference signal, which the regulator receives from the Kalman filter KF (see FIG. 3). This reference signal is only updated after the reception of a new synchronization message. Consequently, the LQR regulator can also be configured as time-discrete. The discrete control variable at each time k when the k-th synchronization message arrives in the slave node is applied to the continuous plant via the ZOH element ZOH in FIG. 3. The continuously controlled time is sampled after each arrival of a synchronization message resulting in the following discrete dynamics of the plant:

\hat{x}ₙ^{C}(k))=\hat{x}ₙ^{C}(k−1)+oₙ(k−1)·aₙ(k) Eq. (20)

The LQR regulator is now implemented based on these discrete dynamics of the controlled system, where the above equation (19) can be used to calculate the controlled time at any time between the arrival of two consecutive synchronization messages.

In the presently described embodiment, the LQR regulator is used to calculate the optimal control sequence {oₙ(k)}ₖ₌₀^{K-1} to follow the output of the Kalman filter KF. Here, the control sequence is selected such that the following LQR cost function is minimized:

$$J ( o ) = {\sum }_{k = 1}^{K} {( {\hat{x}}_{n}^{in , KF} ( k , k ) - {\hat{x}}_{n}^{C} ( k ) )}^{2} + {\sum }_{k = 1}^{K} r \cdot {( {o}_{n} ( k ) - {\hat{R}}_{n} ( k ) )}^{2} \qquad Eq . ( 21 )$$

This means that the deviation of the controlled time from the reference time and the deviation of the control variable from the “reference-control variable” \hat{R}ₙ(k) is to be minimized. The variable r represents a weighting factor which can be suitably defined by the person skilled in the art. The LQR regulator is a linear state regulator with feedback. Consequently, the following relationship applies, as is generally the case for linear state regulators:

oₙ(k)−\hat{R}ₙ(k)=k^{LQR}·(\hat{x}ₙ^{C}(k)−\hat{x}ₙ^{in,KF}(k,k)) Eq. (22)

To calculate the OCF factor according to equation (22), it is necessary to calculate the feedback gain k^{LQR}. In the case of a LQR regulator, the feedback gain, which minimizes the cost function according to equation (21), is expressed by:

$${k}^{LQR} = - \frac{{a}_{n} \cdot p}{r + {a}_{n}^{2} \cdot p} \qquad Eq . ( 23 )$$

Here, p is the solution to the assigned discrete algebraic Riccati equation, i.e., the following applies:

$$p = 1 + p - \frac{{a}_{n}^{2} \cdot {p}^{2}}{r + {a}_{n}^{2} p} \qquad Eq . ( 24 )$$

Here, it is assumed that aₙ(k)=aₙ is always constant. The solution to equation (24) produces the following expression:

$$p = \frac{{a}_{n} \pm \sqrt{{a}_{n}^{2} + 4 r}}{2 {a}_{n}} \qquad Eq . ( 25 )$$

However, if p should be positive-definite, then the following applies:

$$p = \frac{{a}_{n} + \sqrt{{a}_{n}^{2} + 4 r}}{2 {a}_{n}} \qquad Eq . ( 26 )$$

The use of this result in the above equation (23) produces the following expression for k^{LQR}:

$$\begin{matrix}{k}^{LQR} = - \frac{{a}_{n} \cdot p}{r + {a}_{n}^{2} \cdot p} \\ = - \frac{1}{\frac{r}{{a}_{n} \cdot p} + {a}_{n}} \\ = - \frac{1}{\frac{2 r}{{a}_{n} + \sqrt{{a}_{n}^{2} + 4 r}} + {a}_{n}}\end{matrix} \qquad Eq . ( 27 )$$

Using the definition:

$$β = \frac{2 r}{{a}_{n} + \sqrt{{a}_{n}^{2} + 4 r}} , \qquad Eq . ( 28 )$$

the LQR feedback gain can be expressed as follows:

$${k}^{LQR} = - \frac{1}{β + {a}_{n}} \qquad Eq . ( 29 )$$

Here, β is a positive value between zero and infinity and it is within the capacity of the person skilled in the art to define a suitable value for β for an LQR regulator. In the problem under consideration here, a value for β of between 5 and 20 has been found to be suitable.

Finally, if the above equation (29) is used in equation (22), the following optimal choice is obtained for the control variable in the form of the OCF factor:

$${o}_{n} ( k ) = {\hat{R}}_{n} ( k ) + \frac{( {\hat{x}}_{n}^{in , KF} ( k , k ) - {\hat{x}}_{n}^{C} ( k ) )}{β + {a}_{n}} \qquad Eq . ( 30 )$$

Here, aₙ is the control interval in the local time of the slave node SLn, where the nominal synchronization interval between two consecutive synchronization messages, which is constant, can be used as the value for aₙ. The variable \hat{R}ₙ(k) is expressed by the above equation (6) and the variable \hat{x}ₙ^{in,KF}(k,k) is expressed by the above equation (15). The parameter β regulates the magnitude of the fluctuations in the control variable oₙ(k). If β is selected low, the LQR regulator reacts more quickly to errors, but this can result in large oscillations. If β is selected larger, the controlled time converges slowly toward the time according to the reference clock of the master node, but the fluctuation after convergence is lower. As previously explained, a suitable choice of β is within the capacity of the person skilled in the art.

With the embodiment of the method in accordance with the disclosed embodiments of the invention, the respective slave nodes can be synchronized with the time of the master node via a controlled local time regulated by an LQR regulator. Here, the content of the synchronization messages is used to propagate an estimation of the first cycle counting state of the master-slave with the associated estimated variance to the next node. With a respective slave node, its local time is controlled optimally using the LQR regulator, where the combination of the Kalman filter with the LQR regulator obtains an optimal LQG regulator as the inventors were able to demonstrate mathematically.

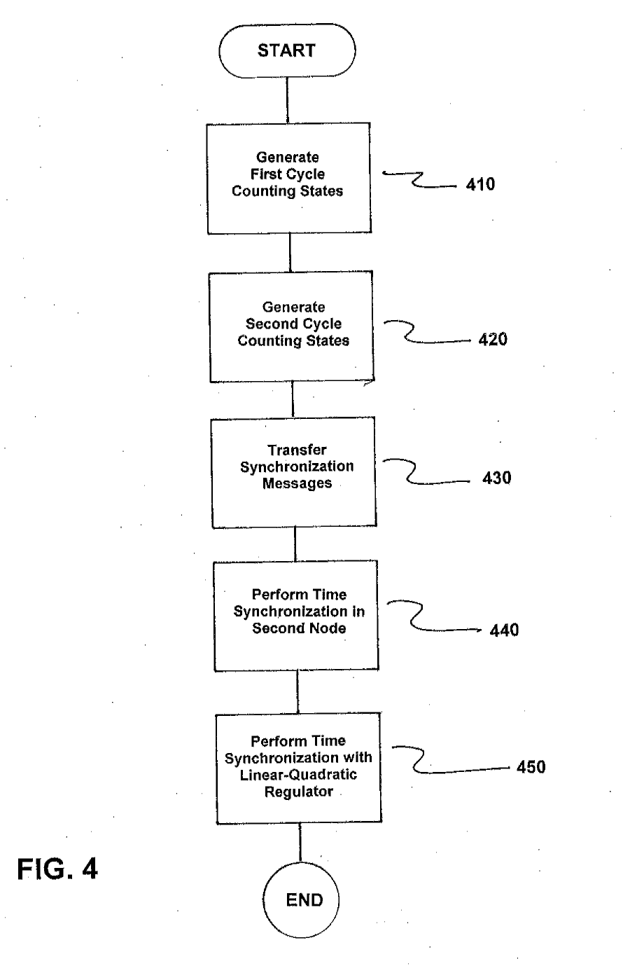

FIG. 4 is a flowchart of a method for time synchronization in a communication network having a plurality of nodes, where each of the plurality of nodes comprises a first node and at least one second node. The method comprises generating, by a first node of the plurality of nodes, first cycle counting states according to a reference cycle frequency, as indicated in step 410.

Second cycle counting states are generated by the at least one second node according to an internal cycle frequency, as indicated in step 420.

Starting from the first node of the plurality of nodes, synchronization messages are then transferred consecutively from a node of the plurality of nodes to a further node of the plurality of nodes to perform time synchronization in consecutive synchronization cycles, as indicated in step 430. Each synchronization message transmitted from the node of the plurality of nodes contains a segment of information that is used for time synchronization in a node receiving the synchronization message.

Next, time synchronization is performed in a respective second node of at least a part of the at least one second node such that a first cycle counting state for a second cycle counting state measured in the respective second node is estimated based on an estimation method dependent on the segment of information in the received synchronization message, as indicated in step 440.

Time synchronization is then performed in the respective second node of the at least a part of the at least one second node with a linear-quadratic regulator to determine a controlled first cycle counting state based on a controlled system from the estimated first cycle counting state, as indicated in step 450. The controlled first cycle counting state contains a compensation factor as a control variable, which estimates a current duty cycle ratio of a reference cycle frequency to an internal cycle frequency of the respective second node, and the controlled first cycle counting state indicates a synchronized time.

While there have shown and described and pointed out fundamental novel features of the invention as applied to a preferred embodiment thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-17. (canceled)

18. A method for time synchronization in a communication network having a plurality of nodes, each of the plurality of nodes comprising a first node and at least one second node, the method comprising:
generating, by a first node of the plurality of nodes, first cycle counting states according to a reference cycle frequency;
generating, by the at least one second node, second cycle counting states according to an internal cycle frequency;
transferring, starting from the first node of the plurality of nodes, synchronization messages consecutively from a node of the plurality of nodes to a further node of the plurality of nodes to perform time synchronization in consecutive synchronization cycles, each synchronization message transmitted from the node of the plurality of nodes containing a segment of information which is used for the time synchronization in a node receiving the synchronization message; and
i) performing time synchronization in a respective second node of at least a part of the at least one second node such that a first cycle counting state for a second cycle counting state measured in the respective second node is estimated based on an estimation method dependent on the segment of information in a received synchronization message; and
ii) performing the time synchronization in the respective second node of the at least a part of the at least one second node using a linear-quadratic regulator to determine a controlled first cycle counting state based on a controlled system from the estimated first cycle counting state, the controlled first cycle counting state containing a compensation factor as a control variable, which estimates a current duty cycle ratio of a reference cycle frequency to an internal cycle frequency of the respective second node,
wherein the controlled first cycle counting state indicates a synchronized time.

19. The method as claimed in claim 18, further comprising:
updating the control variable after each reception of a synchronization message in the respective second node; and
supplying the updated control variable to the controlled system.

20. The method as claimed in claim 19, wherein the controlled system for the linear-quadratic regulator at the time of reception of a synchronization message in the k-th synchronization cycle in the n-th second node and immediately before the update of the control variable is in accordance with the relationship:
\hat{x}ₙ^{C}(k)=\hat{x}ₙ^{C}(k−1)+oₙ(k−1)·aₙ(k);
wherein \hat{x}ₙ^{C}(k) is the controlled first cycle counting state at a time of reception of the synchronization message in a k-th synchronization cycle;
wherein oₙ(k−1) is a compensation factor used in the (k−1)-th synchronization cycle; and
wherein aₙ(k) is a time difference between two synchronization messages received consecutively in the respective second node, expressed in second cycle counting states according to the internal cycle frequency of an n-th second node.

21. The method as claimed in claim 20, wherein the controlled system for the linear-quadratic regulator after the update of the control variable at the time of reception of the synchronization message in the k-th synchronization cycle in the n-th second node until a next update of the control variable is in accordance with the relationship:
xₙ^{C}=\hat{x}ₙ^{C}(k)+oₙ(k)·(Sₙ−TS(Sₙⁱⁿ(k)));
wherein xₙ^{C} is the controlled first cycle counting state at a time of a measured second cycle counting state Sₙ of the respective second node between the update of the control variable at the time of reception of the synchronization message in the k-th synchronization cycle in the n-th second node and the next update of the control variable; and
wherein TS(Sₙⁱⁿ(k)) is the measured second cycle counting state of the respective second node at the time of reception of the synchronization message in the k-th synchronization cycle.

22. The method as claimed in claim 20, wherein a compensation factor oₙ(k) for the k-th synchronization cycle is in accordance with the relationship:
$${o}_{n} ( k ) = {\hat{R}}_{n} ( k ) + \frac{( {\hat{x}}_{n}^{in} - {\hat{x}}_{n}^{C} ( k ) )}{β + {a}_{n} ( k )} ;$$
wherein \hat{R}ₙ(k) is an estimated value for the duty cycle ratio of the reference cycle frequency to the internal cycle frequency of the n-th second node;
wherein \hat{x}ₙⁱⁿ is the first cycle counting state estimated in step i); and
wherein β is a positive factor.

23. The method as claimed in claim 21, wherein a compensation factor oₙ(k) for the k-th synchronization cycle is in accordance with the relationship:
$${o}_{n} ( k ) = {\hat{R}}_{n} ( k ) + \frac{( {\hat{x}}_{n}^{in} - {\hat{x}}_{n}^{C} ( k ) )}{β + {a}_{n} ( k )} ;$$
wherein \hat{R}ₙ(k) is an estimated value for the duty cycle ratio of the reference cycle frequency to the internal cycle frequency of the n-th second node;
wherein \hat{x}ₙⁱⁿ is the first cycle counting state estimated in step i); and
wherein β is a positive factor.

24. The method as claimed in claim 18, wherein the first cycle counting state in step i) is estimated using an estimation method comprising a stochastic state estimator (KF).

25. The method as claimed in claim 24, wherein the first cycle counting state is estimated using an estimation method comprising a Kalman filter, which estimates the first cycle counting state at a time of reception of the synchronization message in the respective second node and an associated stochastic variance as a state and uses the segment of information in the received synchronization message as an observable.

26. The method as claimed in claim 25, wherein the segment of information in the synchronization message comprises an estimated first cycle counting state at a time of transmission of the synchronization message in the respective second node and an associated stochastic variance.

27. The method as claimed in claim 26, wherein the following state space model for the Kalman filter is used in an n-th second node for a k-th synchronization cycle:
xₙⁱⁿ(k)=xₙⁱⁿ(k−1)+aₙ(k)·\hat{R}ₙ(k)+aₙ(k)·ηₙ^{a}(k); and
xₙ₋₁^{out}(k)=xₙⁱⁿ(k)−cₙ(k)·\hat{R}ₙ(k)−cₙ(k)·ηₙ^{c}(k)+vₙ(k);
wherein xₙⁱⁿ(k) is the first cycle counting state at the time of reception of the synchronization message in the n-th second node in the k-th synchronization cycle;
wherein xₙ₋₁^{out}(k) is the first cycle counting state at the time of transmission of the synchronization message in one of an (n−1)-th second node and the first node in a k-th synchronization cycle;
wherein aₙ(k) is a time difference between two synchronization messages received consecutively in the n-th second node, expressed in second cycle counting states according to the internal cycle frequency of the n-th second node;
wherein \hat{R}ₙ(k) is an estimated value for the current duty cycle ratio of the reference cycle frequency to the internal cycle frequency of the n-th second node;
wherein cₙ(k) is an estimated time delay between the time of transmission of the synchronization message from the (n−1)-th second node and the time of reception of this synchronization message in the n-th second node, expressed in second cycle counting states according to the internal cycle frequency of the n-th second node; and
wherein ηₙ^{a}(k), ηₙ^{c}(k) and υₙ(k) are Gaussian noise terms.

28. The method as claimed in claim 26, wherein the estimated first cycle counting state at the time of transmission of the subsequent synchronization message in the respective second node and the associated stochastic variance are calculated from the first cycle counting state estimated by the Kalman filter at the time of reception of the synchronization message in the respective second node and the associated stochastic variance dependent on a node processing time; and inserted in the subsequent synchronization message; and
wherein the node processing time indicates an estimated time delay in the respective second node between the reception of the synchronization message received in the respective second node and the transmission of the subsequent synchronization message.

29. The method as claimed in claim 27, wherein the estimated first cycle counting state at the time of transmission of the subsequent synchronization message in the respective second node and the associated stochastic variance are calculated from the first cycle counting state estimated by the Kalman filter at the time of reception of the synchronization message in the respective second node and the associated stochastic variance dependent on a node processing time; and inserted in the subsequent synchronization message; and
wherein the node processing time represents an estimated time delay in the respective second node between the reception of the synchronization message received in the respective second node and the transmission of the subsequent synchronization message.

30. The method as claimed in claim 18, wherein the time synchronization is based on one of Institute of Electrical and Electronic Engineers (IEEE) standard 1588, International Electrotechnical Commission (IEC) standard 61588 and IEEE standard 802.1AS.

31. The method as claimed in claim 18, wherein each of the plurality of nodes intercommunicate based on the PROFINET-Standard.

32. The method as claimed in claim 18, wherein the method is implemented in an industrial automation system.

33. The method as claimed in claim 19, wherein the updated control variable is supplied to the plant via a zero-order hold (ZOH) element.

34. The method as claimed in claim 22, wherein the positive factor is between about 5 and 20.

35. The method as claimed in claim 23, wherein the positive factor is between about 5 and 20.

36. The method as claimed in claim 24, wherein the stochastic state estimator (KF) is a Kalman filter.

37. A node for use as a second node in a method for time synchronization in a communication network having a plurality of nodes, each of the plurality of nodes comprising a first node and at least one second node, the first node generating first cycle counting states according to a reference cycle frequency and the at least one second node generating second cycle counting states according to an internal cycle frequency, wherein time synchronization is performed in consecutive synchronization cycles, in which, starting from the first node, synchronization messages are transferred consecutively from a node of the plurality of nodes to a further node of the plurality of nodes and a synchronization message transmitted from the node of the plurality of nodes includes a segment of information, which is used for time synchronization in the node of the plurality of nodes receiving the synchronization message;
wherein the second node is configured to perform time synchronization during operation such that:
i) a first cycle counting state for a second cycle counting state measured in the respective second node is estimated based on an estimation method dependent on the segment of information in a received synchronization message; and
ii) a linear-quadratic regulator is used to determine a controlled first cycle counting state based on a controlled system from the estimated first cycle counting state, which contains a compensation factor as a control variable, the controlled first cycle counting state estimating a current duty cycle ratio of a reference cycle frequency to an internal cycle frequency of the respective second node;
wherein the controlled first cycle counting state indicates the synchronized time.

38. A communication network comprising:
a plurality of nodes, the plurality of nodes comprising a first node and at least one second node;
wherein the first node of the plurality of nodes generates first cycle counting states during operation according to a reference cycle frequency, and the at least one second node generates second cycle counting states during operation according to an internal cycle frequency;
wherein time synchronization is performed in consecutive synchronization cycles in which, starting from the first node, synchronization messages are consecutively transferred from a node of the plurality of nodes to a further node of the plurality of nodes and a synchronization message transmitted from a node of the plurality of nodes includes a segment of information, which is used for time synchronization in the node of the plurality of nodes that receives the synchronization message; and
wherein the at least one second node is configured to perform time synchronization during operation such that:
i) a first cycle counting state for a second cycle counting state measured in the respective second node is estimated based on an estimation method dependent on the segment of information in a received synchronization message; and
ii) a linear-quadratic regulator is used to determine a controlled first cycle counting state based on a controlled system from the estimated first cycle counting state, which contains a compensation factor as a control variable, the controlled first cycle counting state estimating a current duty cycle ratio of a reference cycle frequency to an internal cycle frequency of the respective second node;
wherein the controlled first cycle counting state indicates the synchronized time.

39. The communication network as claimed in claim 37, wherein the control variable is updated after each reception of the synchronization message in the respective second node and supplied to the controlled system.
